(19) United States
(12) Patent Application Publication
(10) Pub. No.: US 2025/0304814 A1
(43) Pub. Date: Oct. 2, 2025

(54) Treatment Liquid And Recording Method

(71) Applicant: SEIKO EPSON CORPORATION, Tokyo (JP)

(72) Inventors: Kunihiro FUJITA, Shiojiri (JP); Takayoshi KAGATA, Shiojiri (JP); Haruka SATO, Shiojiri (JP)

(21) Appl. No.: 19/092,261

(22) Filed: Mar. 27, 2025

(30) Foreign Application Priority Data
Mar. 28, 2024 (JP) 2024-055091

(51) Int. Cl. C09D 11/54; C09D 11/033; C09D 11/102; C09D 11/104; C09D 11/30; D06P 1/52; D06P 5/20; D06P 5/24; D06P 5/30

(52) U.S. Cl. CPC C09D 11/54; C09D 11/033; C09D 11/102; C09D 11/104; C09D 11/30; D06P 1/5271; D06P 1/5285; D06P 5/007; D06P 5/2055; D06P 5/30

(57) ABSTRACT

A treatment liquid of the present disclosure to be printed on a transfer medium includes a material containing resin particles, a water-soluble organic solvent, a silicone-based surfactant, and water. A content of the resin particles is 5.0% by mass or more and 20.0% by mass or less, the water-soluble organic solvent contains a substance A and a substance B, a content of the substance A is 5.0% by mass or more and 20.0% by mass or less, a content of the substance B is 0.1% by mass or more and 3.0% by mass or less, and a content of the organic solvent having a boiling point of higher than 230° C. is 10.0% by mass or less.

### TREATMENT LIQUID AND RECORDING METHOD

The present application is based on, and claims priority from JP Application Serial Number 2024-055091, filed Mar. 28, 2024, the disclosure of which is hereby incorporated by reference herein in its entirety.

### BACKGROUND

### 1. Technical Field

The present disclosure relates to a treatment liquid and a recording method.

### 2. Related Art

There is known a transfer printing method in which a transfer sheet, which is a transfer medium on which an image is formed, is superimposed on a medium to be transferred such as a cloth and the image is transferred to the medium to be transferred by heating and pressurization. In such a method, when forming an image on the transfer sheet, an ink jet method is often used because it is advantageous in forming a fine image with high on-demand performance.

In the transfer printing method described above, an image is generally formed on the transfer sheet including a release layer and a hot melt layer formed on the entire surface of a base material, and then the transfer sheet is heated and pressurized to transfer the image to a medium to be transferred.

JP-A-2013-059973 discloses a method for manufacturing a transfer medium. The method includes a colored layer forming step of ejecting ink from an ink jet head toward a base material to form a colored layer on the base material, and an adhesive layer forming step of ejecting an adhesive liquid, which is an aqueous liquid containing a polyester resin in an emulsion form having a glass transition temperature of 10° C. or higher and 70° C. or lower, from the ink jet head toward the colored layer to form an adhesive layer on the colored layer. JP-A-2013-059973 describes that the above-described configuration makes it possible to provide a method for manufacturing a transfer medium that has excellent ejection stability when ejecting the adhesive liquid from the ink jet head, can obtain a high-resolution pattern of the colored layer, and is excellent in transferability, adhesion after transfer, and blocking resistance.

### SUMMARY

JP-A-2013-059973 discloses the use of a plastic or a metal as a medium to be transferred, but does not disclose the use of an absorptive medium to be transferred such as a fabric. When the transfer medium described in JP-A-2013-059973 is applied to an absorptive medium to be transferred such as a fabric for transfer, a problem of migration, that is, a problem in which a dye moves from a site where the dye originally exists in the medium to be transferred to another site occurs in a case where the medium to be transferred is dyed with the dye. Therefore, there is a demand for providing a recording method that can effectively prevent occurrence of the problem of migration, and a treatment liquid that can be used in the recording method.

The present disclosure is made to solve the problem, and can be realized in the following application examples.

According to an application example of the present disclosure, there is provided a treatment liquid that is to be printed on a transfer medium and includes a material containing resin particles, a water-soluble organic solvent, a silicone-based surfactant, and water, in which a content of the resin particles is 5.0% by mass or more and 20.0% by mass or less, the water-soluble organic solvent contains a substance A and a substance B, a content of the substance A is 5.0% by mass or more and 20.0% by mass or less, a content of the substance B is 0.1% by mass or more and 3.0% by mass or less, and a content of the organic solvent having a boiling point of higher than 230° C. is 10.0% by mass or less. (Provided that, the substance A is at least one compound selected from diols in which a solubility in water at 25° C. is more than 1.00 [g/100 g of H₂O] and a boiling point is 230° C. or lower, and the substance B is at least one compound selected from the group of compounds in which the solubility in water at 25° C. is 0.10 [g/100 g of H₂O] or more and 1.00 [g/100 g of H₂O] or less.)

According to another application example of the present disclosure, there is provided a recording method including: a first layer forming step of forming a first layer by ejecting an ink for image formation from an ink jet head onto a transfer medium including a release layer; a second layer forming step of forming a second layer by ejecting a treatment liquid from the ink jet head to overlap the first layer; and a heat transfer step of heat-transferring the first layer and the second layer to an absorptive medium to be transferred by heating a surface of the transfer medium on which the first layer and the second layer are formed in a state of facing the medium to be transferred, in which as the treatment liquid, a treatment liquid including a material containing resin particles, a water-soluble organic solvent, a silicone-based surfactant, and water is used, a content of the resin particles is 5.0% by mass or more and 20.0% by mass or less, the water-soluble organic solvent contains a substance A and a substance B, a content of the substance A is 5.0% by mass or more and 20.0% by mass or less, a content of the substance B is 0.1% by mass or more and 3.0% by mass or less, and a content of the organic solvent having a boiling point of higher than 230° C. is 10.0% by mass or less. (Provided that, the substance A is at least one compound selected from diols in which a solubility in water at 25° C. is more than 1.00 [g/100 g of H₂O] and a boiling point is 230° C. or lower, and the substance B is at least one compound selected from the group of compounds in which the solubility in water at 25° C. is 0.10 [g/100 g of H₂O] or more and 1.00 [g/100 g of H₂O] or less.)

### BRIEF DESCRIPTION OF THE DRAWINGS

FIG. 1 is a process diagram illustrating a recording method according to a preferred embodiment of the present disclosure.

FIG. 2 is a table showing compositions of ink for image formation of Preparation Examples 1 to 3.

FIG. 3 is a table showing compositions of treatment liquids of Examples A1 to A12.

FIG. 4 is a table showing the compositions of treatment liquids of Examples A13 to A16 and Comparative Examples A1 to A7.

FIG. 5 is a table collectively showing conditions of recording methods of Examples B1 to B12.

FIG. 6 is a table collectively showing conditions of recording methods of Examples B13 to B16 and Comparative Examples B1 to B7.

FIG. 7 is a table collectively showing evaluation results of Examples A1 to A12 and Examples B1 to B12.

FIG. 8 is a table collectively showing evaluation results of Examples A13 to A16, Examples B13 to B16, Comparative Examples A1 to A7, and Comparative Examples B1 to B7.

### DESCRIPTION OF EMBODIMENTS

Hereinafter, preferred embodiments of the present disclosure will be described in detail.

The embodiments described below describe examples of the present disclosure. The present disclosure is not limited to the following embodiments, and includes various modifications implemented within a range not changing a gist of the present disclosure. Furthermore, it should be noted that not all of the configurations described below are essential configurations of the present disclosure.

### 1. Treatment Liquid

First, a treatment liquid of the present disclosure will be described.

The treatment liquid of the present disclosure is a treatment liquid that is to be printed on a transfer medium and includes a material containing resin particles, a water-soluble organic solvent, a silicone-based surfactant, and water. The content of the resin particles in the treatment liquid of the present disclosure is 5.0% by mass or more and 20.0% by mass or less, the water-soluble organic solvent contains a substance A and a substance B, the content of the substance A is 5.0% by mass or more and 20.0% by mass or less, the content of the substance B is 0.1% by mass or more and 3.0% by mass or less, and the content of the organic solvent having a boiling point of higher than 230° C. is 10.0% by mass or less. However, the substance A is at least one compound selected from diols in which a solubility in water at 25° C. is more than 1.00 [g/100 g of H₂O] and a boiling point is 230° C. or lower, and the substance B is at least one compound selected from the group of compounds in which a solubility in water at 25° C. is 0.10 [g/100 g of H₂O] or more and 1.00 [g/100 g of H₂O] or less.

As a result, it is possible to provide a treatment liquid that is excellent in ejection stability by an ink jet method, is excellent in transferability even when being applied to an absorptive medium to be transferred, and can effectively prevent occurrence of a problem of migration. That is, it is possible to effectively prevent occurrence of transfer failure and the problem of migration in a case where a recording portion with the treatment liquid printed on the transfer medium is transferred to the absorptive medium to be transferred.

On the other hand, in a case where the above-described conditions are not satisfied, a satisfactory result cannot be obtained.

For example, in a case where the water-soluble organic solvent contains the substance A but does not contain the substance B, the problem of migration is likely to occur significantly when the recording portion with the treatment liquid which is printed on the transfer medium is transferred to the absorptive medium to be transferred.

In addition, when the water-soluble organic solvent contains the substance B but does not contain the substance A, the ejection stability of the treatment liquid by the ink jet method is significantly lowered.

In addition, even when the water-soluble organic solvent contains the substance A and the substance B, when the content of the substance A is less than the lower limit value, the ejection stability of the treatment liquid by the ink jet method cannot be sufficiently excellent.

In addition, even when the water-soluble organic solvent contains the substance A and the substance B, when the content of the substance A exceeds the upper limit value, the problem of migration is likely to occur significantly in a case where the recording portion with the treatment liquid which is printed on the transfer medium is transferred to the absorptive medium to be transferred.

In addition, even when the water-soluble organic solvent contains the substance A and the substance B, when the content of the substance B is less than the lower limit value, the ejection stability of the treatment liquid by the ink jet method cannot be sufficiently excellent.

In addition, even when the water-soluble organic solvent contains the substance A and the substance B, when the content of the substance B exceeds the upper limit value, storage stability of the treatment liquid and the ejection stability by the ink jet method are significantly lowered.

In addition, when the content of the organic solvent having a boiling point of higher than 230° C. is too high, the problem of migration is likely to occur significantly in a case where the recording portion with the treatment liquid which is printed on the transfer medium is transferred to the absorptive medium to be transferred.

In addition, when the treatment liquid does not contain the silicone-based surfactant, the storage stability of the treatment liquid and the ejection stability by the ink jet method are significantly lowered.

Note that in the present specification, the boiling point refers to a boiling point at 1 atmospheric pressure unless otherwise specified.

### 1-1. Resin Particles

The treatment liquid of the present disclosure contains resin particles.

The resin particles contained in the treatment liquid of the present disclosure are usually water-based resin particles having excellent dispersibility in a liquid containing water as a main component.

As a result, adhesion of the recording portion formed by a recording method to be described in detail later to the medium to be transferred can be made excellent, and durability of a manufactured recorded matter can be made excellent.

In particular, the treatment liquid of the present disclosure contains a resin having a particle form.

As a result, the ejection stability of the treatment liquid by the ink jet method can be made excellent, and the recorded matter to be described later can be manufactured more stably. In the recording method which will be described in detail later, it is possible to effectively prevent a liquid component from unintentionally remaining in the recording portion.

The average particle size of the resin particles in the treatment liquid is preferably 30 nm or more and 3 μm or less, more preferably 50 nm or more and 1 μm or less, and even more preferably 60 nm or more and 300 nm or less.

As a result, the effect described above is more remarkably exhibited.

Note that in the present specification, the average particle size refers to a volume-based average particle size, and can be obtained, for example, by adding a sample to methanol and measuring a dispersed solution, which is obtained by dispersing the sample for 3 minutes, with an ultrasonic disperser by using a 50 μm aperture with a Coulter counter method particle size distribution measuring instrument (TA-II type manufactured by COULTER ELECTRONICS INS).

Examples of a resin material constituting the resin particles include a polyurethane resin, a polyester resin, a polyvinyl chloride, a styrene acrylic resin, an acrylic resin, and the like, and one or two or more selected from these can be used in combination. However, the resin particles are preferably made of a material containing at least one of a urethane resin and a polyester resin.

As a result, the transferability of the recording portion, which is formed by a recording method to be described in detail later, to the medium to be transferred, the durability of recorded matter to be manufactured, and the like can be made more excellent. In particular, when the resin particles are made of a material containing a polyester resin, the following effects are obtained. That is, in the related art, in a case where the medium to be transferred is a polyester fabric, the transferability of the recording portion from the transfer medium to the medium to be transferred and the durability of the recorded matter tend to be inferior, but in the present disclosure, it is possible to effectively prevent occurrence of such a problem. In other words, in the present disclosure, when the resin particles are made of a material containing a polyester resin, even in a case where a polyester fabric transfer medium is used as the medium to be transferred, the transferability of the recording portion from the transfer medium to the medium to be transferred, and durability such as washing fastness of the recorded matter can be made sufficiently excellent.

A glass transition temperature of the resin material constituting the resin particles is preferably −20° C. or higher and 50° C. or lower, more preferably −10° C. or higher and 45° C. or lower, and even more preferably 0° C. or higher and 40° C. or lower.

As a result, the texture and the durability such as the washing fastness of the recorded matter manufactured by using the recording method to be described in detail later can be made more excellent.

A melting point of the resin material constituting the resin particles is preferably 80° C. or higher and 140° C. or lower, more preferably 85° C. or higher and 130° C. or lower, and even more preferably 90° C. or higher and 120° C. or lower.

As a result, the texture and the durability such as the washing fastness of the recorded matter manufactured by using the recording method to be described in detail later can be made more excellent.

The content of the resin particles in the treatment liquid of the present disclosure may be 5.0% by mass or more and 20.0% by mass or less, but is preferably 7.0% by mass or more and 18.0% by mass or less, and more preferably 8.0% by mass or more and 17.0% by mass or less.

As a result, the above-described effect of the present disclosure is remarkably exhibited.

### 1-2. Water-Soluble Organic Solvent

The treatment liquid of the present disclosure contains a water-soluble organic solvent.

As a result, the viscosity and surface tension of the treatment liquid can be suitably adjusted. For example, the moisture retention properties of the treatment liquid are excellent, unintentional precipitation of the solid content of the treatment liquid due to drying or the like in the ink jet head or the like, and the like are effectively prevented, clogging recovery properties can be made excellent, and the ejection stability of the treatment liquid can be made excellent.

In particular, the treatment liquid of the present disclosure contains the substance A and the substance B, which will be described below, as the water-soluble organic solvent in a predetermined content.

That is, the water-soluble organic solvent contains at least one compound selected from diols in which a solubility in water at 25° C. is more than 1.00 [g/100 g of H₂O] and a boiling point is 230° C. or lower as the substance A, and at least one compound selected from the group of compounds in which a solubility in water at 25° C. is 0.10 [g/100 g of H₂O] or more and 1.00 [g/100 g of H₂O] or less as the substance B. The content of the substance A in the treatment liquid of the present disclosure is 5.0% by mass or more and 20.0% by mass or less, the content of the substance B is 0.1% by mass or more and 3.0% by mass or less, and the content of the organic solvent having a boiling point of higher than 230° C. is 10.0% by mass or less.

### 1-2-1. Substance A

The substance A is at least one compound selected from diols having a solubility in water at 25° C. of more than 1.00 [g/100 g of H₂O] and a boiling point of 230° C. or lower. Since the substance A tends to have a high affinity for water, the ejection stability of the treatment liquid can be secured even when the substance B, which will be described later, is contained in the treatment liquid.

The solubility of the substance A in water at 25° C. may be more than 1.00 [g/100 g of H₂O], is preferably 5.0 [g/100 g of H₂O] or more, and more preferably 10.0 [g/100 g of H₂O] or more. In particular, it is preferable that the substance A is compatible with water in any ratio at 25° C.

As a result, the above-described effect of the present disclosure is remarkably exhibited.

The boiling point of the substance A may be 230° C. or lower, and is preferably 170° C. or higher and 225° C. or lower.

As a result, the above-described effect of the present disclosure is remarkably exhibited.

Examples of compounds that satisfy the above-described conditions of the solubility and the boiling point with respect to water include propylene glycol (miscible, boiling point: 188° C.), 1,3-propanediol (miscible, boiling point: 214° C.), 1,2-butanediol (miscible, boiling point: 194° C.), 1,3-butanediol (miscible, boiling point: 207° C.), 1,2-hexanediol (miscible, boiling point: 224° C.), and the like. One or two or more selected from the compounds can be used as the substance A in combination. However, the substance A is preferably at least one of propylene glycol and 1,2-hexanediol, and more preferably contains both propylene glycol and 1,2-hexanediol.

As a result, the above-described effect of the present disclosure is remarkably exhibited.

When the substance A constituting the treatment liquid of the present disclosure contains both propylene glycol and 1,2-hexanediol, it is preferable that the following conditions are satisfied. That is, when the content of propylene glycol in the treatment liquid of the present disclosure is X_{PG} [% by mass] and the content of 1,2-hexanediol in the treatment liquid is X_{HD} [% by mass], it is preferable that 0.10≤X_{HD}/X_{PG}≤0.60 is satisfied, more preferable that 0.15≤X_{HD}/X_{PG}≤0.50 is satisfied, and even more preferable that 0.20≤X_{HD}/X_{PG}≤0.40 is satisfied.

As a result, the above-described effect of the present disclosure is further remarkably exhibited.

The content of the substance A in the treatment liquid of the present disclosure may be 5.0% by mass or more and 20.0% by mass or less, but is preferably 6.0% by mass or more and 17.0% by mass or less, and more preferably 7.0% by mass or more and 15.0% by mass or less.

As a result, the above-described effect of the present disclosure is remarkably exhibited.

### 1-2-2. Substance B

The substance B is at least one compound selected from the group of compounds having a solubility in water at 25° C. of 0.10 [g/100 g of H₂O] or more and 1.00 [g/100 g of H₂O] or less. Since the substance B tends to have low affinity with water, the substance B has high affinity with a low-absorption or non-absorption transfer medium, and it is possible to improve wet spread of the treatment liquid containing the substance B with respect to the transfer medium. Therefore, when the treatment liquid contains the substance B, drying properties of the treatment liquid is improved, and it is possible to effectively prevent the liquid component capable of dissolving a dye present in the medium to be transferred from remaining in a heat transfer step to be described later.

The solubility of the substance B in water at 25° C. may be 0.10 [g/100 g of H₂O] or more and 1.00 [g/100 g of H₂O] or less, but is preferably 0.12 [g/100 g of H₂O] or more and 0.98 [g/100 g of H₂O] or less, more preferably 0.15 [g/100 g of H₂O] or more and 0.95 [g/100 g of H₂O] or less, and even more preferably 0.60 [g/100 g of H₂O] or more and 0.93 [g/100 g of H₂O] or less.

As a result, the above-described effect of the present disclosure is remarkably exhibited.

The boiling point of the substance B is preferably 210° C. or higher and 330° C. or lower, more preferably 240° C. or higher and 310° C. or lower, and even more preferably 250° C. or higher and 270° C. or lower.

As a result, the above-described effect of the present disclosure is remarkably exhibited.

Examples of compounds that satisfy the above-described conditions of the solubility and the boiling point of water include 2,2′-butylethyl-1,3-propanediol, 1,2-octanediol, ethylhexylglycerin, diethylene glycol monoethyl hexyl ether, N-octyl-2-pyrrolidone, and the like, and one or two or more selected from the compounds can be used as the substance B in combination, but the substance B is preferably 2,2′-butylethyl-1,3-propanediol.

As a result, the above-described effect of the present disclosure is remarkably exhibited.

In particular, in a case where the substance A contains both propylene glycol and 1,2-hexanediol and the substance B is 2,2′-butylethyl-1,3-propanediol, these components act in a synergistic manner, and the effect of the present disclosure described above is further remarkably exhibited.

The content of the substance B in the treatment liquid of the present disclosure may be 0.1% by mass or more and 3.0% by mass or less, but is preferably 0.2% by mass or more and 2.0% by mass or less, and more preferably 0.3% by mass or more and 1.2% by mass or less.

As a result, the above-described effect of the present disclosure is remarkably exhibited.

When the content of the substance A in the treatment liquid of the present disclosure is X_{A} [% by mass] and the content of the substance B in the treatment liquid is X_{B} [% by mass], it is preferable that 0.01≤X_{B}/X_{A}≤0.60 is satisfied, more preferable that 0.02≤X_{B}/X_{A}≤0.40 is satisfied, and even more preferable that 0.03≤X_{B}/X_{A}≤0.20 is satisfied.

As a result, the above-described effect of the present disclosure is further remarkably exhibited.

### Other Solvent Components

The water-soluble organic solvent constituting the treatment liquid of the present disclosure may contain the above-described substance A and substance B in a predetermined range, and may further contain components other than the substance A and the substance B. Hereinafter, such components are also referred to as “other solvent components”.

The solubility of the other solvent components in water at 25° C. is preferably 0.05 [g/100 g of H₂O] or more, more preferably 0.10 [g/100 g of H₂O] or more, and even more preferably 0.15 [g/100 g of H₂O] or more.

The content of the other solvent components in the treatment liquid of the present disclosure is preferably 2.5% by mass or less, more preferably 2.0% by mass or less, and even more preferably 1.0% by mass or less.

### 1-2-4. Other Conditions

The content of the water-soluble organic solvent in the treatment liquid of the present disclosure is preferably 5.1% by mass or more and 25.0% by mass or less, more preferably 6.2% by mass or more and 20.0% by mass or less, and even more preferably 7.2% by mass or more and 17.0% by mass or less.

As a result, the viscosity and the surface tension of the treatment liquid can be adjusted more suitably. In addition, the moisture retention properties of the treatment liquid are more excellent, unintentional precipitation of the solid content of the treatment liquid due to drying or the like in the ink jet head or the like, and the like are more effectively prevented, the clogging recovery properties can be made more excellent, and the ejection stability of the treatment liquid can be made more excellent.

The content of the organic solvent having a boiling point of higher than 230° C. in the treatment liquid of the present disclosure is 10.0% by mass or less.

As described above, by setting the content of the organic solvent having a high boiling point to be equal to or less than the predetermined value, it is possible to more effectively prevent the above-described problem of migration.

As described above, the content of the organic solvent having a boiling point of higher than 230° C. in the treatment liquid of the present disclosure may be 10.0% by mass or less, but is preferably 3.0% by mass or less, more preferably 2.0% by mass or less, and even more preferably 1.2% by mass or less.

As a result, the above-described effect of the present disclosure is remarkably exhibited.

### 1-3. Silicone-Based Surfactant

The treatment liquid of the present disclosure contains a silicone-based surfactant. The silicone-based surfactant is a component that can effectively reduce the surface tension of the treatment liquid containing the substance B.

Examples of the silicone-based surfactant include BYK-306, BYK-307, BYK-333, BYK-341, BYK-345, BYK-346, BYK-348, BYK-349, and BYK-3455 manufactured by BYK Chemie Japan KK, Silface SAG503A, SAG002, SAG005, and SAGO14 manufactured by Nissin Chemical Co., Ltd., KF-351A, KF-352A, KF-353, KF-354L, KF-355A, KF-615A, KF-945, KF-640, KF-642, KF-643, KF-6020, X-22-4515, KF-6011, and KF-6012 manufactured by Shin-Etsu Chemical Co., Ltd., and the like, and one or two or more selected from the surfactants can be used in combination.

The content of the silicone-based surfactant in the treatment liquid of the present disclosure is preferably 0.02% by mass or more and 1.50% by mass or less, more preferably 0.05% by mass or more and 1.00% by mass or less, and even more preferably 0.10% by mass or more and 0.70% by mass or less.

As a result, the ejection stability of the treatment liquid by the ink jet method can be made more excellent.

### 1-4. Water

The treatment liquid of the present disclosure contains water.

Normally, the treatment liquid of the present disclosure is a water-based ink composition containing water as a main component.

Water is a component that functions as a dispersion medium for dispersing, for example, resin particles in the treatment liquid of the present disclosure.

The content of water in the treatment liquid of the present disclosure is preferably 50.0% by mass or more and 85.0% by mass or less, more preferably 55.0% by mass or more and 80.0% by mass or less, and even more preferably 60.0% by mass or more and 75.0% by mass or less.

### 1-5. Other Components

The treatment liquid of the present disclosure may contain components other than the above-described components. Hereinafter, such components will also be referred to as “other components” in this section.

Examples of other components include surfactants other than the silicone-based surfactant, resin materials contained in a dissolved state, chelating agents, preservatives, antifungal agents, rust inhibitors, flame retardants, various dispersants, pH adjusting agents such as triethanolamine, antioxidants, UV absorbers, oxygen absorbers, dissolution aids, penetrants, and the like.

Examples of the surfactant other than the silicone-based surfactant include various nonionic surfactants other than the silicone-based surfactant, cationic surfactants, anionic surfactants, and the like.

Examples of the nonionic surfactant other than the silicone-based surfactant include acetylene glycol-based surfactants, and the like.

Examples of acetylene glycol-based surfactants include Surfynol 82, 465, 485, 2502, Olfine E1004, E1010, E1020, PD-002W, PD-004, EXP4001, EXP4002, EXP4123, and EXP4300 manufactured by Nissin Chemical Co., Ltd., and Acetylenol E00, E103T, E40, E60, E100, E200, and the like manufactured by Kawaken Fine Chemicals Co., Ltd. (Surfynol and Olfine are registered trademarks).

However, it is preferable that the treatment liquid of the present disclosure does not contain a fluorine-based surfactant. In addition, it is preferable that the treatment liquid of the present disclosure does not contain a coloring material.

The content of the other components in the treatment liquid of the present disclosure is preferably 6.0% by mass or less, and more preferably 5.0% by mass or less.

Note that a lower limit of the content of the other component is 0% by mass.

### 1-6. Other Conditions

The viscosity of the treatment liquid of the present disclosure at 25° C. is preferably 2 mPa·s or more and 10 mPa·s or less, and more preferably 3 mPa·s or more and 8 mPa·s or less.

As a result, clogging of nozzles of an ink jet head or the like is less likely to occur, and the ejection stability of the treatment liquid is further improved. In addition, even in a case where clogging of the nozzles occurs, recovery properties can be made excellent by capping the nozzles.

The surface tension of the treatment liquid of the present disclosure at 25° C. is not particularly limited, but is preferably 20 mN/m or more and 60 mN/m or less, more preferably 25 mN/m or more and 50 mN/m or less, and even more preferably 27 mN/m or more and 40 mN/m or less.

As a result, clogging of nozzles of an ink jet head or the like is less likely to occur, and the ejection stability of the treatment liquid is further improved. In addition, even in a case where clogging of the nozzles occurs, recovery properties can be made excellent by capping the nozzles.

### 2. Recording Method

Next, a recording method of the present disclosure will be described.

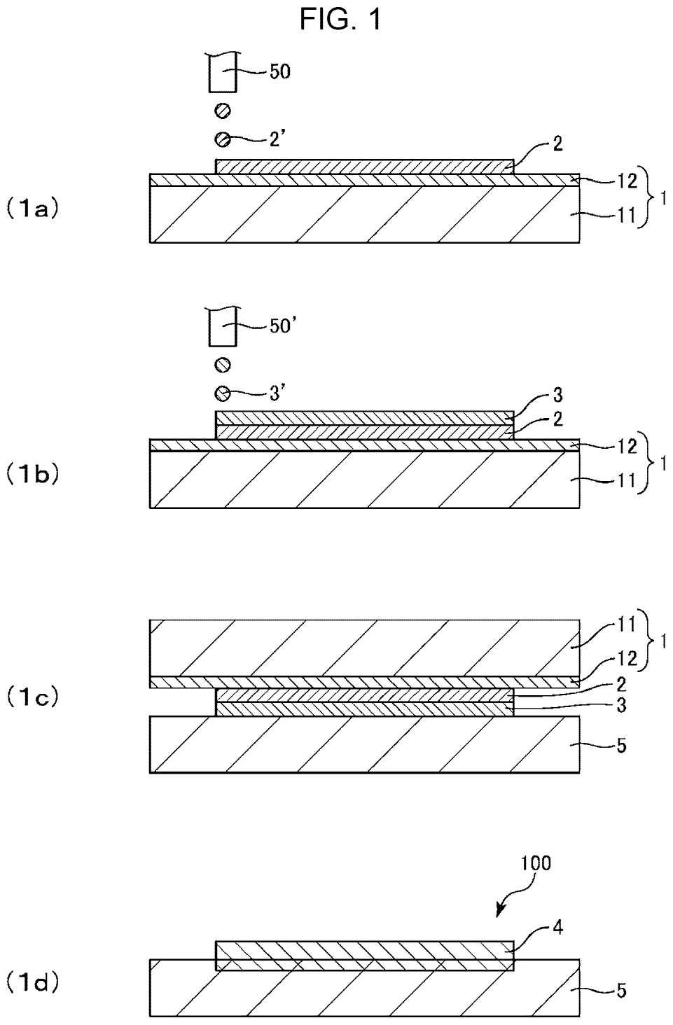

FIG. 1 is a process diagram illustrating a preferred embodiment of the recording method of the present disclosure.

The recording method of the present disclosure includes a first layer forming step (1a) of forming the first layer 2 by ejecting an ink 2′ for image formation from an ink jet head 50 onto a transfer medium 1 including a release layer 12, a second layer forming step (1b) of forming a second layer 3 by ejecting a treatment liquid 3′ from an ink jet head 50′ to overlap the first layer 2, and a heat transfer step (1d) of heat-transferring the first layer 2 and the second layer 3 to an absorptive medium 5 to be transferred by heating a surface of the transfer medium 1 on which the first layer 2 and the second layer 3 are formed in a state of facing the medium 5 to be transferred. The treatment liquid 3′ is used to satisfy the conditions described in 1. That is, as the treatment liquid 3′, a material containing resin particles, a water-soluble organic solvent, a silicone-based surfactant, and water is used, the content of the resin particles is 5.0% by mass or more and 20.0% by mass or less, the water-soluble organic solvent contains the substance A and the substance B, the content of the substance A is 5.0% by mass or more and 20.0% by mass or less, the content of the substance B is 0.1% by mass or more and 3.0% by mass or less, and the content of the organic solvent having a boiling point of higher than 230° C. is 10.0% by mass or less. However, the substance A is at least one compound selected from diols in which a solubility in water at 25° C. is more than 1.00 [g/100 g of H₂O] and a boiling point is 230° C. or lower, and the substance B is at least one compound selected from the group of compounds in which a solubility in water at 25° C. is 0.10 [g/100 g of H₂O] or more and 1.00 [g/100 g of H₂O] or less.

As a result, it is possible to provide a recording method capable of stably manufacturing recorded matter while effectively preventing occurrence of transfer failure and the problem of migration.

Note that in the present disclosure, the absorptive medium refers to a medium having a property of absorbing a liquid, and quantitatively refers to a medium in which the amount of water absorption from the start of contact to 30 msec^{1/2} in a Bristow method is more than 10 mL/m². In addition, a non-absorptive or low-absorptive medium refers to a medium having a property of not absorbing or hardly absorbing a liquid, and quantitatively refers to a medium in which the amount of water absorption from the start of contact to 30 msec^{1/2} in the Bristow method is 10 mL/m² or less. The Bristow method is the most popular method for measuring the amount of liquid absorption in a short time and is also adopted by Japan Technical Association of the Pulp and Paper Industry (JAPAN TAPPI). Details of the test method are laid out in the standard No. 51 “JAPAN TAPPI Paper Pulp Test Method 2000 Edition” under “Paper and paperboard-Liquid absorbency test method-Bristow method”.

### 2-1. First Layer Forming Step

In the first layer forming step, the first layer 2 is formed by ejecting the ink 2′ for image formation from the ink jet head 50 to the transfer medium 1 including the release layer 12 (1a). 2-1-1. Transfer Medium

The transfer medium 1 may be any medium as long as the transfer medium 1 includes the release layer 12, but in the present embodiment, the transfer medium 1 includes a base material 11 and the release layer 12.

As a result, a handling property of the transfer medium 1 is made more excellent.

A shape of the transfer medium 1 is not particularly limited, and a sheet-like transfer medium is preferably used. As a result, the first layer 2 and the second layer 3 can be more suitably formed by the ink jet method.

Examples of a constituent material of the base material 11 include paper, a plastic material, a metal material, and the like. Among these, the plastic material is preferable. Since the plastic material is non-absorptive, constituent materials of the first layer 2 and the second layer 3 can be suitably prevented from being absorbed by the base material 11 and remaining unintentionally after the heat transfer step.

Examples of the plastic material constituting the base material 11 include a polyester such as polyethylene terephthalate, a polyolefin such as polyethylene, polypropylene, and the like.

The base material 11 may have any shape, but is preferably in a sheet shape.

When the base material 11 is in the sheet shape, the thickness of the base material 11 is preferably 50 μm or more and 200 μm or less.

The release layer 12 is a layer having releasability. Since the transfer medium 1 includes the release layer 12, it is possible to suitably prevent the constituent materials of the first layer 2 and the second layer 3 from remaining on the transfer medium 1 after the heat transfer step in an unintended manner.

The release layer 12 is preferably non-absorptive or low-absorptive.

As a result, the constituent materials of the first layer 2 and the second layer 3 can be more suitably prevented from being absorbed by the release layer 12 and remaining unintentionally after the heat transfer step.

Examples of the constituent material of the release layer 12 include a polyethylene wax-based release agent, a silicone-based release agent, a fluorine-based release agent, and the like.

The thickness of the release layer 12 is not particularly limited, but is preferably 5 μm or more and 80 μm or less, and more preferably 10 μm or more and 50 μm or less.

In particular, the transfer medium 1 preferably includes an ink-receiving layer containing an inorganic oxide as the release layer 12.

As a result, a higher definition image can be formed.

### Ink for Image Formation

The ink 2′ for image formation is an ink used for forming an image to be transferred to the medium 5 to be transferred.

The ink 2′ for image formation contains a coloring material and water.

### 2-1-2-1. Coloring Material

Examples of the coloring material included in the ink 2′ for image formation include pigments such as various inorganic pigments and organic pigments, various dyes, and the like, and one or two or more selected from the coloring materials can be used in combination, but the pigments are particularly preferable.

Examples of the inorganic pigments include carbon blacks such as furnace black, lamp black, acetylene black, and channel black, iron oxide, titanium oxide, and the like.

Examples of the organic pigments include azo pigments such as insoluble azo pigments, condensed azo pigments, azo lakes, and chelate azo pigments, polycyclic pigments such as phthalocyanine pigments, perylene and perinone pigments, anthraquinone pigments, quinacridone pigments, dioxane pigments, thioindigo pigments, isoindolinone pigments, and quinophthalone pigments, dye chelates such as basic dye type chelates and acid dye type chelates, dyeing lakes such as basic dye type lakes and acid dye type lakes, nitro pigments, nitroso pigments, aniline black, daylight fluorescent pigments, and the like.

More specifically, examples of the carbon blacks used as black pigments include No. 2300, No. 900, MCF88, No. 33, No. 40, No. 45, No. 52, MA7, MA8, MA100, No. 2200B, and the like (all manufactured by Mitsubishi Chemical Group Corporation), Raven 5750, Raven 5250, Raven 5000, Raven 3500, Raven 1255, Raven 700, and the like (all manufactured by Columbia Carbon Inc.), Regal 400R, Regal 330R, Regal 660R, Mogul L, Monarch 700, Monarch 800, Monarch 880, Monarch 900, Monarch 1000, Monarch 1100, Monarch 1300, Monarch 1400, and the like (all manufactured by Cabot Corporation), Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, Special Black 4 (all manufactured by Evonik Industries AG), and the like.

Examples of white pigments include C. I. Pigment White 6, 18, 21, and the like.

Examples of yellow pigments include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, 180, and the like.

Examples of magenta pigments include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, 245, or C.I. Pigment Violet 19, 23, 32, 33, 36, 38, 43, and 50, and the like.

Examples of blue-violet pigments include C.I. Pigment Blue 1, 2, 3, 15, 15:1, 15:2, 15:3, 15:34, 15:4, 16, 18, 22, 25, 60, 65, 66, C.I. Vat Blue 4, 60, and the like.

In addition, examples of pigments other than the above-described pigments include C.I. Pigment Green 7, 10, C.I. Pigment Brown 3, 5, 25, 26, C.I. Pigment Orange 1, 2, 5, 7, 13, 14, 15, 16, 24, 34, 36, 38, 40, 43, 63, and the like.

The ink 2′ for image formation may contain a self-dispersing pigment as a coloring material.

The self-dispersing pigment is a self-dispersing pigment having a hydrophilic group on a pigment surface, and examples of the hydrophilic group include —OM, —COOM, —CO—, —SO₃M, —SO₂M, —SO₂NH₂, —RSO₂M, —PO₃HM, —PO₃M₂, —SO₂NHCOR, —NH₃, —NR₃, and the like. Note that in the formulae, M represents a hydrogen atom, an alkali metal, ammonium, or organic ammonium, and R represents a naphthyl group which may have an alkyl group or a substituent having 1 or more 12 or less carbon atoms. In addition, for example, a phenyl group may be present between the pigment surface and the hydrophilic group.

The self-dispersing pigment can be manufactured, for example, by binding the hydrophilic group to the pigment surface by performing a physical treatment or a chemical treatment on the pigment. Examples of the physical treatment include a vacuum plasma treatment and the like. Examples of the chemical treatment include a wet oxidation method in which oxidation with an oxidizing agent occurs in water, and the like.

In addition, as the self-dispersing pigment, for example, a self-dispersing pigment that is surface-treated by an oxidation treatment with a hypohalogenous acid and/or a hypohalogenous acid salt, an oxidation treatment with ozone, or an oxidation treatment with a persulfuric acid and/or a persulfuric acid salt is preferable in terms of high color development. In addition, commercially available products can also be used as the self-dispersing pigment, and preferable examples thereof include Microjet CW1 (manufactured by Orient Chemical Industries Co., Ltd.), CAB-O-JET 250C, CAB-O-JET 260M, CAB-O-JET 270Y, and CAB-O-JET 444MP (all manufactured by Cabot Corporation), and the like.

The content of the coloring material in the ink 2′ for image formation is not particularly limited, but is preferably 1.0% by mass or more and 25.0% by mass or less, more preferably 2.0% by mass or more and 20.0% by mass or less, and even more preferably 5.0% by mass or more and 15.0% by mass or less.

As a result, in the recording portion 4 formed by using the ink 2′ for image formation, it is easy to secure a sufficient color density, and it is possible to make color development properties on the medium 5 to be transferred more excellent, and it is possible to make the storage stability of the ink 2′ for image formation, the ejection stability by the ink jet method, the clogging recovery properties in the ink jet head, and the like more excellent.

### 2-1-2-2. Water

The ink 2′ for image formation contains water.

Water is a component that functions as a dispersion medium for dispersing a coloring material or a solvent for dissolving the coloring material in the ink 2′ for image formation.

The content of water in the ink 2′ for image formation is preferably 50.0% by mass or more and 75.0% by mass or less, more preferably 52.0% by mass or more and 70.0% by mass or less, and even more preferably 54.0% by mass or more and 65.0% by mass or less.

### 2-1-2-3. Organic Solvent

The ink 2′ for image formation may contain an organic solvent.

As a result, the viscosity and the surface tension of the ink 2′ for image formation can be suitably adjusted. In addition, for example, the moisture retention properties of the ink 2′ for image formation are excellent, unintentional precipitation of the solid content of the ink 2′ for image formation due to drying or the like in the ink jet head or the like, and the like can be more effectively prevented, the clogging recovery properties can be made more excellent, and the ejection stability of the ink 2′ for image formation can be made more excellent.

As the organic solvent, a water-soluble organic solvent is preferably used.

As such a water-soluble organic solvent, an organic solvent having a solubility of 10 g/100 g of water or more in water at 25° C. can be suitably used.

Examples of the organic solvent contained in the ink 2′ for image formation, in particular, the water-soluble organic solvent include a polyol compound, a glycol ether, a cyclic amide compound, and the like, and one or two or more selected from the organic solvents can be used in combination.

Examples of the polyol compound include a polyol compound in which the number of carbon atoms in the molecule is 2 or more and 6 or less and one ether bond may be present in the molecule, and preferably, a diol compound, and the like. Specific examples thereof include glycols such as 1,2-pentanediol, glycerin, ethylene glycol, diethylene glycol, triethylene glycol, polyethylene glycol, propylene glycol, dipropylene glycol, tripropylene glycol, polypropylene glycol, polyoxyethylene polyoxypropylene glycol, 1,2-hexanediol, 1,2-heptanediol, 1,3-propanediol, 1,2-butanediol, 1,3-butanediol, 1,4-butanediol, 2,3-butanediol, 2-methyl-3-phenoxy-1,2-propanediol, 3-(3-methylphenoxy)-1,2-propanediol, 3-hexyloxy-1,2-propanediol, 2-hydroxymethyl-2-phenoxymethyl-1,3-propanediol, 3-methyl-1,3-butanediol, 1,5-pentanediol, 1,6-hexanediol, 2-methyl-2,4-pentanediol, 3-methyl-1,5-pentanediol, and the like.

Examples of the glycol ether include a monoalkyl ether of a glycol selected from ethylene glycol, diethylene glycol, triethylene glycol, polyethylene glycol, propylene glycol, dipropylene glycol, tripropylene glycol, polypropylene glycol, and polyoxyethylene polyoxypropylene glycol. Examples of the monoalkyl ether include triethylene glycol monomethyl ether, triethylene glycol monobutyl ether, triethylene glycol monoethyl ether, dipropylene glycol monopropyl ether, and the like.

Examples of the cyclic amide compound include 2-pyrrolidone, N-methyl-2-pyrrolidone, N-hydroxyethyl-2-pyrrolidone, 1,3-dimethylimidazolinone, 2-piperidone (δ-valerolactam), N-cyclohexyl-2-pyrrolidone, and the like.

The content of the organic solvent in the ink 2′ for image formation is preferably 5.0% by mass or more and 35.0% by mass or less, more preferably 10.0% by mass or more and 30.0% by mass or less, and even more preferably 15.0% by mass or more and 25.0% by mass or less.

As a result, the viscosity and the surface tension of the ink 2′ for image formation can be adjusted more suitably. In addition, the moisture retention properties of the ink 2′ for image formation are more excellent, unintentional precipitation of the solid content of the ink 2′ for image formation due to drying or the like in the ink jet head or the like, and the like are more effectively prevented, the clogging recovery properties can be made more excellent, and the ejection stability of the ink 2′ for image formation can be made more excellent.

### 2-1-2-4. Resin

The ink 2′ for image formation may contain a resin.

As a result, for example, the adhesion of the recording portion 4 containing the coloring material to the medium 5 to be transferred can be made more excellent. In addition, when the ink 2′ for image formation contains a pigment, dispersion stability of the pigment in the ink 2′ for image formation can be made more excellent.

However, the content of the resin in the ink 2′ for image formation is preferably 15.0% by mass or less, more preferably 2.0% by mass or more and 13.0% by mass or less, even more preferably 4.0% by mass or more and 12.0% by mass or less, and most preferably 7.0% by mass or more and 11.0% by mass or less.

As a result, the dispersion stability of the pigment in the ink 2′ for image formation, and the adhesion of the recording portion 4 to the medium 5 to be transferred can be made more excellent while making the ejection stability of the ink 2′ for image formation by the ink jet method, the stability of the manufacturing of recorded matter 100, and the texture of the recorded matter 100 more excellent.

In a case where the ink 2′ for image formation contains a resin, a form of the resin in the ink 2′ for image formation is not particularly limited. For example, in the ink 2′ for image formation, the resin may be contained in the ink 2′ in a dispersed state or in a dissolved state, but it is preferable that the resin is contained in the ink 2′ in a dispersed state.

As a result, the ejection stability of the ink 2′ for image formation by the ink jet method can be made more excellent, and the recorded matter 100 can be more stably manufactured.

In a case where the resin is contained in the ink 2′ for image formation in a dispersed state, an average particle size of the resin is preferably 30 nm or more and 3 μm or less, more preferably 50 nm or more and 1 μm or less, and even more preferably 60 nm or more and 300 nm or less.

As a result, the effect described above is more remarkably exhibited.

Examples of the resin contained in the ink 2′ for image formation include polyurethane, polyester, a styrene acrylic resin, an acrylic resin, polyvinyl chloride, and the like, and one or two or more selected from the resins can be used in combination. Among these, polyurethane is preferable.

As a result, the effect described above is more remarkably exhibited.

A glass transition temperature of the resin contained in the ink 2′ for image formation is preferably −40° C. or higher and 0° C. or lower, more preferably −35° C. or higher and −5° C. or lower, and even more preferably −30° C. or higher and −10° C. or lower.

As a result, the texture and the durability such as washing fastness of the manufactured recorded matter 100 can be made more excellent.

When the content of the resin in the ink 2′ for image formation is set as XR [% by mass] and the content of the coloring material is set as XP [% by mass], it is preferable to satisfy 0.2≤XR/XP≤1.8, more preferably 0.6≤XR/XP≤1.5, and even more preferably 0.8≤XR/XP≤1.2.

As a result, in the recording portion 4 formed by using the ink 2′ for image formation, it is easy to secure a sufficient color density, it is possible to make the color development properties on the medium to be transferred more excellent, and it is possible to make the storage stability of the ink 2′ for image formation, the ejection stability by the ink jet method, the clogging recovery properties in the ink jet head, and the like more excellent. In addition, the texture of the recorded matter 100 and the adhesion of the recording portion 4 to the medium 5 to be transferred can be made more excellent.

### 2-1-2-5. Surfactant

The ink 2′ for image formation may contain a surfactant.

As the surfactant, for example, various surfactants such as an anionic surfactant, a cationic surfactant, and a nonionic surfactant can be used.

When the ink 2′ for image formation contains the surfactant, the content of the surfactant in the ink 2′ for image formation is preferably 0.02% by mass or more and 1.50% by mass or less, more preferably 0.05% by mass or more and 1.00% by mass or less, and even more preferably 0.10% by mass or more and 0.70% by mass or less.

### 2-1-2-6. Other Components

The ink 2′ for image formation may contain components other than the above-described components. Hereinafter, such components will also be referred to as “other components” in this section.

Examples of other components include chelating agents, preservatives, antifungal agents, rust inhibitors, flame retardants, various dispersants, pH adjusting agents such as triethanolamine, antioxidants, ultraviolet absorbers, oxygen absorbers, dissolution aids, penetrants, and the like.

Examples of the chelating agents include an ethylenediamine tetraacetate, and the like. In addition, examples of the preservatives and antifungal agents include sodium benzoate, sodium pentachlorophenol, sodium 2-pyridine thiol-1-oxide, sodium sorbate, sodium dehydroacetate, 1,2-dibenzoisothiazolin-3-one, 4-chloro-3-methylphenol, and the like. In addition, examples of the rust inhibitors include benzotriazole and the like.

As the preservatives and the antifungal agents, for example, a compound having an isothiazoline ring structure in a molecule can be suitably used.

The content of the other components in the ink 2′ for image formation is preferably 6.0% by mass or less, and more preferably 5.0% by mass or less.

### 2-1-2-7. Other Conditions

The viscosity of the ink 2′ for image formation at 25° C. is preferably 2 mPa·s or more and 10 mPa·s or less, and more preferably 3 mPa·s or more and 8 mPa·s or less.

As a result, clogging of the nozzles of the ink jet head or the like is less likely to occur, and the ejection stability of the ink 2′ for image formation is further improved. In addition, even in a case where clogging of the nozzles occurs, recovery properties can be made excellent by capping the nozzles.

Note that the viscosity can be obtained by measuring the viscosity with a vibration type viscometer, a rotation type viscometer, a capillary type viscometer, or a falling ball type viscometer. For example, with the vibration type viscometer, the viscosity can be obtained by measurement in accordance with JIS Z8809.

The surface tension of the ink 2′ for image formation at 25° C. is not particularly limited, but is preferably 20 mN/m or more and 60 mN/m or less, more preferably 25 mN/m or more and 50 mN/m or less, and even more preferably 27 mN/m or more and 40 mN/m or less.

As a result, clogging of the nozzles of the ink jet head or the like is less likely to occur, and the ejection stability of the ink 2′ for image formation is further improved. In addition, even in a case where clogging of the nozzles occurs, recovery properties can be made excellent by capping the nozzles.

Note that as the surface tension, it is possible to adopt a value measured by a Wilhelmy method or a ring method. For the measurement of the surface tension, it is possible to use a surface tension meter (for example, DY-300, DY-500, DY-700, and the like, manufactured by Kyowa Interface Science Co., Ltd.).

### 2-1-3. Ejection by Ink jet Method

The first layer 2 is formed by ejecting the ink 2′ for image formation onto the transfer medium 1 including the release layer 12 by the ink jet method. More specifically, the ink 2′ for image formation is ejected to come into contact with the release layer 12 of the transfer medium 1.

Examples of the ink jet method include an on-demand method such as a charge deflection type, a continuous type, a piezoelectric type, and a bubble jet (registered trademark) type, and the like, but the piezoelectric type, which is a type of ejecting an ink from an ink jet head by using a piezo oscillator, is particularly preferable.

As a result, it is possible to more effectively prevent the unintentional denaturation of the components of the ink 2′ for image formation in the ink jet head 50, and the like, and to make the ejection stability by the ink jet method more excellent.

In addition, examples of the ink jet head 50 include a line head that performs recording in a line method and a serial head that performs recording in a serial method.

In the line method using the line head, for example, an ink jet head having a width equal to or larger than a recording width of the transfer medium 1 is fixed to the recording apparatus. Then, the transfer medium 1 is moved along a sub-scanning direction (a transport direction of the transfer medium 1), and the first layer 2 is formed on the transfer medium 1 by ejecting ink droplets from nozzles of the ink jet head 50 in conjunction with the movement.

In the serial method using the serial head, for example, the ink jet head 50 is mounted on a carriage that can move in a width direction of the transfer medium 1. Then, the carriage is moved along a main scanning direction (a width direction of the transfer medium 1), and the first layer 2 is formed on the transfer medium 1 by ejecting ink droplets from nozzles of a serial head, which is the ink jet head 50, in conjunction with the movement.

In the present step, the first layer 2 is formed as an inverted image of the recording portion 4 to be formed on the medium 5 to be transferred.

In the present step, a plurality of types of the ink 2′ for image formation may be used.

For example, as the ink for image formation, a first ink for image formation containing a coloring material of a color other than white and a second ink for image formation containing a white pigment may be used. After an image is formed by using the first ink for image formation, an image may be formed by using the second ink for image formation to overlap the image.

As a result, the color development property of the image is improved.

In addition, for example, as the first ink for image formation, at least two or more of a black ink, a cyan ink, a magenta ink, and a yellow ink may be used in combination.

### 2-2. Second Layer Forming Step

In the second layer forming step, the second layer 3 is formed by ejecting a treatment liquid 3′ from an ink jet head 50′ to overlap the first layer 2 formed on the transfer medium 1 (1b).

### 2-2-1. Treatment Liquid

As the treatment liquid 3′, a treatment liquid of the present disclosure is used.

The treatment liquid 3′ preferably satisfies the conditions described in 1.

Thereby, the above-described effect can be obtained.

### 2-2-2. Ejection by Ink Jet Method

The second layer 3 is formed by ejecting the treatment liquid 3′ to the transfer medium 1 on which the first layer 2 is formed by an ink jet method.

Examples of the ink jet method include an on-demand method such as a charge deflection type, a continuous type, a piezoelectric type, and a bubble jet (registered trademark) type, and the like, but the piezoelectric type, which is a type of ejecting an ink from an ink jet head by using a piezo oscillator, is particularly preferable.

As a result, it is possible to more effectively prevent the unintentional denaturation or the like of components of the treatment liquid 3′ in the ink jet head 50′, and to make the ejection stability by the ink jet method more excellent.

In addition, examples of the ink jet head 50′ include a line head that performs recording by a line method and a serial head that performs recording by a serial method.

In the present step, the second layer 3 is formed to overlap the first layer 2, particularly, to have the same pattern as the first layer 2.

In addition, the first layer 2 and the second layer 3 may be formed by using different ink jet recording apparatuses, but it is preferable to form the first layer 2 and the second layer 3 by using the same ink jet recording apparatus.

Although it varies depending on the composition of the ink 2′ for image formation or the like, time from attachment of the ink 2′ for image formation to the transfer medium 1 to attachment of the treatment liquid 3′ is preferably 1 second or longer and 60 seconds or shorter, and more preferably 2 seconds or longer and 30 seconds or shorter.

In addition, in the present step, a plurality of types of the ink 2′ for image formation may be used.

### 2-3. Drying Step

A drying step of drying the transfer medium 1 on which the first layer 2 and the second layer 3 are formed may be further provided between the second layer forming step described above and a heat transfer step described later (1c).

As a result, it is possible to more effectively prevent the liquid component from unintentionally remaining in finally obtained recorded matter 100.

The present step can be performed, for example, by air drying, oven heating, or the like.

When the present step is performed by the air drying, a temperature of the atmosphere in which the transfer medium 1 on which the first layer 2 and the second layer 3 are formed is placed varies depending on the composition of the ink 2′ for image formation, the composition of the treatment liquid 3′, and the like, but is preferably 1° C. or higher and 40° C. or lower, and more preferably 5° C. or higher and 30° C. or lower.

When the present step is performed by the air drying, a humidity of the atmosphere in which the transfer medium 1 on which the first layer 2 and the second layer 3 are formed is placed varies depending on the composition of the ink 2′ for image formation, the composition of the treatment liquid 3′, and the like, but is preferably 10% RH or more and 95% RH or less, and more preferably 20% RH or more and 90% RH or less.

When the present step is performed by the air drying, a pressure of the atmosphere in which the transfer medium 1 on which the first layer 2 and the second layer 3 are formed is placed varies depending on the composition of the ink 2′ for image formation, the composition of the treatment liquid 3′, and the like, but is preferably 1 kPa or more and 150 kPa or less, and more preferably 10 kPa or more and 110 kPa or less.

When the present step is performed by the heating, the temperature of the atmosphere in which the transfer medium 1 on which the first layer 2 and the second layer 3 are formed is placed varies depending on the composition of the ink 2′ for image formation, the composition of the treatment liquid 3′, and the like, but is preferably 80° C. or higher and 220° C. or lower, and more preferably 100° C. or higher and 200° C. or lower.

In a case where the present step is performed by the heating, although it varies depending on the composition of the ink 2′ for image formation or the treatment liquid 3′, and the lik, but time for a drying treatment is preferably 0.2 minutes or longer and 10 minutes or shorter, and more preferably 0.5 minutes or longer and 5 minutes or shorter.

### 2-4. Heat Transfer Step

In the heat transfer step, the first layer 2 and the second layer 3 of the transfer medium 1 are heat-transferred to the medium 5 to be transferred by heating a surface on which the first layer 2 and the second layer 3 are formed in a state of facing the absorptive medium 5 to be transferred, and the recording portion 4 is formed on the medium 5 to be transferred (1d).

### 2-4-1. Medium to be Transferred

The medium 5 to be transferred may be any member as long as the medium 5 is absorptive, and examples thereof include various kinds of papers, porous metals, porous ceramics, porous glass, porous plastics, fabrics, leather, and the like, but fabrics or leather are preferable.

As a result, the printed matter can be transferred to a finished product after sewing the fabric or leather without selecting a place, and good color development and abrasion resistance can be obtained.

In particular, the medium 5 to be transferred is preferably a fabric dyed with a dye.

A material constituting the fabric is not particularly limited, and examples thereof include natural fibers such as cotton, linen, wool, and silk, synthetic fibers such as polypropylene, polyester, acetate, triacetate, polyamide, and polyurethane, biodegradable fibers such as polylactic acid, and the like, and the material may be blended fibers of the fibers.

As the fabric, the fibers described above may be in any form such as a woven fabric, a knitted fabric, and a nonwoven fabric, and may be mixed fibers.

In the present embodiment, examples of the form of the fabric include cloth, garment and other clothing ornaments, and the like. The cloth includes, for example, a woven fabric, a knitted fabric, a nonwoven fabric, and the like. The garment and the other clothing ornaments include, for example, sewn T-shirts, handkerchiefs, scarves, towels, handbags, fabric furniture such as bags, curtains, sheets, bed covers, and wallpaper, cloth before and after cutting as parts to be sewn, and the like. Examples of these forms include a long roll-like product, a product cut into a predetermined size, a product shape, and the like.

### 2-4-2. Heating Conditions

A heating temperature in the present step is not particularly limited, but is preferably 100° C. or higher and 270° C. or lower, more preferably 110° C. or higher and 250° C. or lower, and even more preferably 120° C. or higher and 210° C. or lower.

As a result, it is possible to prevent the constituent materials of the first layer 2 and the second layer 3 from remaining unintentionally on the transfer medium 1 more suitably, and to improve productivity of the recorded matter 100 with energy saving.

When a glass transition temperature of the resin material constituting the resin particles contained in the treatment liquid 3′ is set as Tg [° C.] and the heating temperature in the heat transfer step is set as Tp [° C.], it is preferable to satisfy 70≤Tp-Tg≤290, more preferably 95≤Tp-Tg≤260, and even more preferably 110≤Tp-Tg≤210.

As a result, it is possible to prevent the constituent materials of the first layer 2 and the second layer 3 from remaining unintentionally on the transfer medium 1 more suitably, and to improve productivity of the recorded matter 100 with energy saving.

Heating time in the present step is not particularly limited, but is preferably 5 seconds or longer and 90 seconds or shorter, more preferably 15 seconds or longer and 70 seconds or shorter, and even more preferably 20 seconds or longer and 60 seconds or shorter.

As a result, it is possible to prevent the constituent materials of the first layer 2 and the second layer 3 from remaining unintentionally on the transfer medium 1 more suitably, and to improve productivity of the recorded matter 100 with energy saving.

The present step may be performed by any method as long as the surface of the transfer medium 1 on which the first layer 2 and the second layer 3 are formed is heated in a state of facing the absorptive medium 5 to be transferred, but is preferably performed by a heat press.

As a result, it is possible to prevent the constituent materials of the first layer 2 and the second layer 3 from remaining unintentionally on the transfer medium 1 more suitably, and to improve productivity of the recorded matter 100 with energy saving.

In a case where the present step is performed by the heat press, a pressure applied to a stacked body of the transfer medium 1 and the medium 5 to be transferred is preferably 0.1 N/cm² or more and 30 N/cm² or less, more preferably 0.6 N/cm² or more and 15 N/cm² or less, and even more preferably 1.5 N/cm² or more and 5 N/cm² or less.

### 2-5. Recorded Matter

After the above-described step, the recorded matter 100 is obtained (1e).

The recorded matter 100 obtained as described above includes the recording portion 4 formed by the first layer 2 and the second layer 3.

It is preferable that at least a part of the recording portion 4 intrudes into the absorptive medium 5 to be transferred.

The recording portion 4 is normally configured such that at least a part thereof is integrated with the constituent material of the first layer 2 and the constituent material of the second layer 3, but in the configuration shown in the drawing, the recording portion 4 is configured such that the entirety thereof is integrated with the constituent material of the first layer 2 and the constituent material of the second layer 3.

### 3. Ink and Treatment Liquid Set

Next, an ink and treatment liquid set according to the present disclosure will be described.

The ink and treatment liquid set according to the present disclosure includes an ink for image formation and a treatment liquid.

More specifically, the ink and treatment liquid set according to the present disclosure is preferably provided with the ink for image formation satisfying the conditions described in 2-1-2 and the treatment liquid described in 1.

The ink and treatment liquid set according to the present disclosure may include at least one type of ink for image formation and one type of treatment liquid, respectively, but may include a plurality of types of inks for image formation or a plurality of types of treatment liquids. In addition to the ink for image formation and the treatment liquid satisfying the above-described conditions, the ink and treatment liquid set according to the present disclosure may further include other inks and treatment liquids.

Although the preferred embodiments of the present disclosure have been described above, the present disclosure is not limited thereto.

For example, in the above-described embodiment, a case where the drying step is provided between the second layer forming step and the heat transfer step is mainly described, but the drying step may be omitted.

In addition, the drying step may be performed between the first layer forming step and the second layer forming step.

In addition, in the above-described embodiment, the treatment liquid is ejected to complete the second layer with a desired pattern after the first layer with a desired pattern is completed on the transfer medium, and then the heat transfer step is performed. However, in the present disclosure, a plurality of steps may be performed simultaneously. More specifically, for example, ejection of the ink for image formation and ejection of the treatment liquid may be performed at the same time at different sites of the same transfer medium.

### EXAMPLES

Next, a description will be given of specific examples of the present disclosure.

### 4. Preparation of Ink for Image Formation

### Preparation Example 1

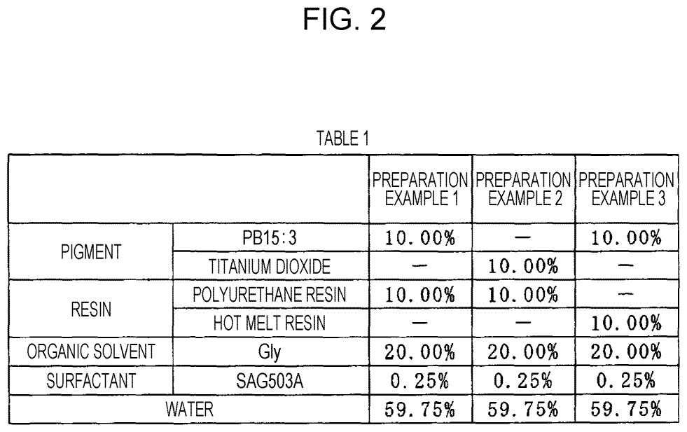

By mixing respective components at predetermined ratios, ink for image formation having a composition shown in FIG. 2 was obtained.

### Preparation Examples 2 and 3

Inks for image formation were prepared in the same manner as in Preparation Example 1 except that types of the components used for preparing the ink for image formation and the mixing ratios of the respective components were changed to have compositions shown in FIG. 2.

The compositions of the inks for image formation of Preparation Examples 1 to 3 are collectively shown in FIG. 2. Note that numerical values indicated by “%” of each component in FIG. 2 indicate the content in units of mass %. In addition, in FIG. 2, C. I. Pigment Blue 15:3 is referred to as “PB 15:3”, a polyurethane resin (solid content of Takelac W6110 manufactured by Mitsui Chemicals, Inc., glass transition temperature of −20° C.) is referred to as “polyurethane resin”, a hot melt resin (solid content of KT08701 manufactured by Unitika Ltd.) is referred to as “hot melt resin”, glycerin, which is a water-soluble organic solvent, is referred to as “Gly”, and Silface SAG503A (manufactured by Nissin Chemical Co., Ltd.), which is a surfactant, is referred to as “SAG503A”. In addition, in the inks for image formation of Preparation Examples 1 to 3, an average particle size of the resin contained was a value in a range of 60 nm or more and 300 nm or less. In addition, in all of the inks for image formation of Preparation Examples 1 to 3, a surface tension was a value within a range of 30 mN/m or more and 40 mN/m or less at 25° C. and a viscosity was a value within a range of 3 mPa·s or more and 8 mPa·s or less at 25° C. Note that the surface tension was measured by the Wilhelmy method by using a surface tension meter (DY-300, manufactured by Kyowa Interface Science Co., Ltd.), and the viscosity was measured in accordance with JIS Z8809 by using a vibration type viscometer (VM-100, manufactured by SEKONIC CORPORATION).

### 5. Preparation of Treatment Liquid

### Example A1

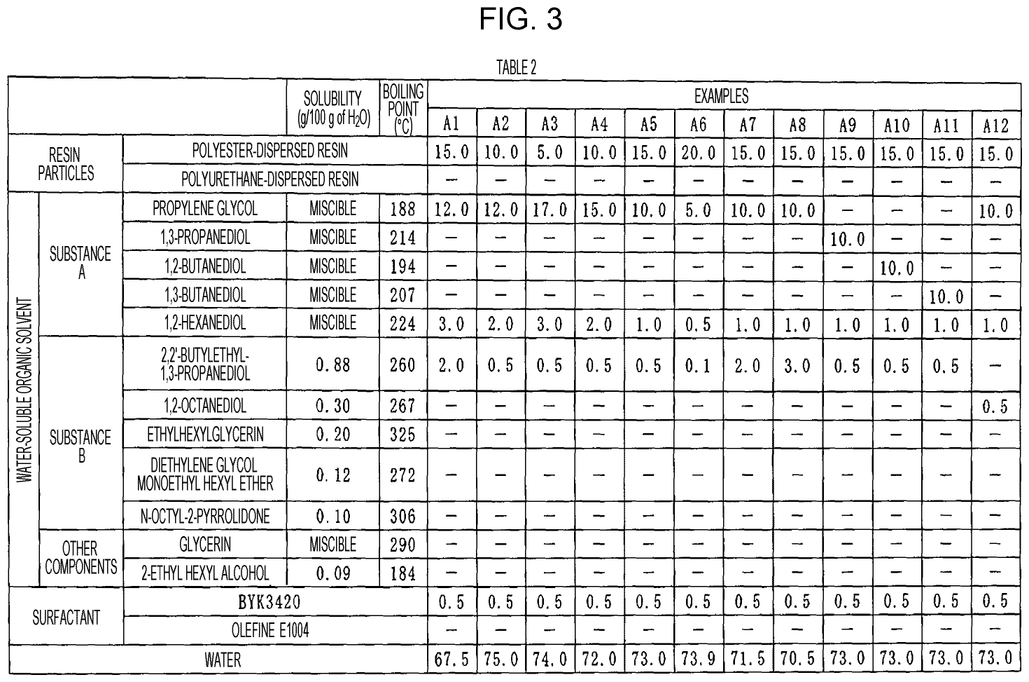

By mixing components at predetermined ratios, a treatment liquid having a composition shown in FIG. 3 was obtained.

### Examples A2 to A16

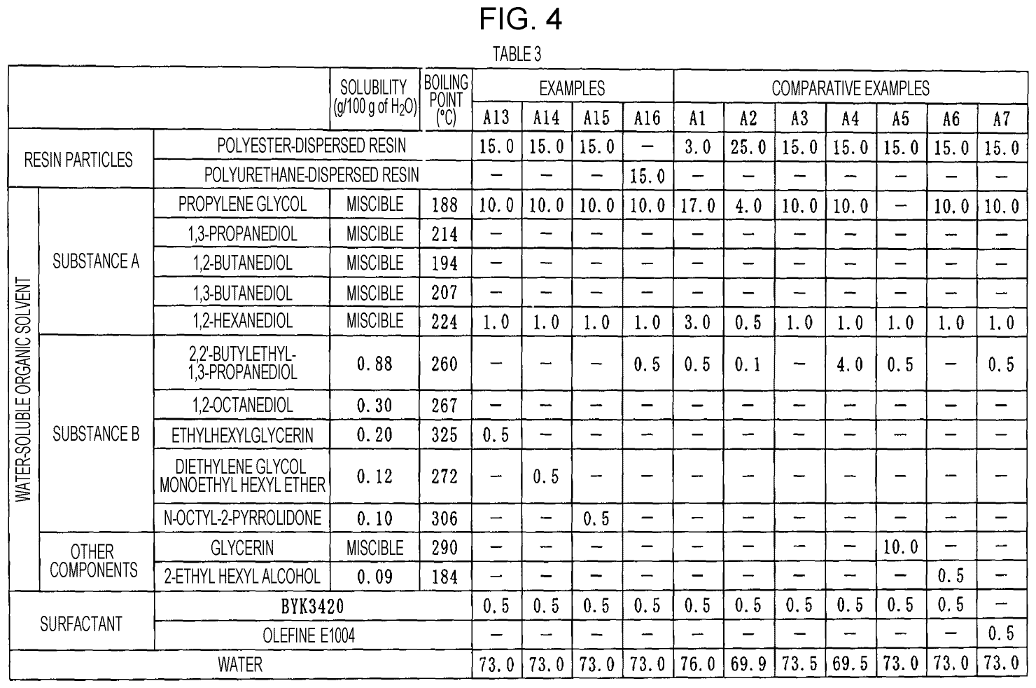

Treatment liquids were prepared in the same manner as in Example A1 except that types of components used for preparing the treatment liquid and mixing ratios of respective components were changed to have compositions shown in FIGS. 3 and 4.

### Comparative Examples A1 to A7

Treatment liquids were prepared in the same manner as in Example A1 except that types of components used for preparing the treatment liquid and the mixing ratios of respective components were changed to have compositions shown in FIG. 4.

The compositions of the treatment liquids of Examples A1 to A16 and Comparative Examples A1 to A7 are collectively shown in FIGS. 3 and 4. Note that in numerical values of the respective components in each of the Examples and Comparative Examples in FIGS. 3 and 4, contents are shown in units of mass %. In addition, in FIGS. 3 and 4, a polyester resin (solid content of KT9204 manufactured by Unitika Ltd.) is referred to as “polyester-dispersed resin”, a polyurethane resin (solid content of Takelac W6061 manufactured by Mitsui Chemicals, Inc.) is referred to as “polyurethane-dispersed resin”, BYK3420 (manufactured by BYK Chemie Japan KK) as a silicone-based surfactant is referred to as “BYK3420”, and Olfine E1004 (manufactured by Nissin Chemical Co., Ltd.), which is not a silicone-based surfactant, as an acetylene glycol-based surfactant is referred to as “Olfine E1004”. In addition, in each of the treatment liquids of Examples A1 to A16, an average particle size of the resin particles contained was a value within a range of 60 nm or more and 300 nm or less. In addition, in each of the treatment liquids of Examples A1 to A16 at 25° C., the surface tension of was a value within a range of 30 mN/m or more and 40 mN/m or less, and the viscosity at 25° C. was a value within a range of 3 mPa·s or more and 8 mPa·s or less. Note that the surface tension was measured by the Wilhelmy method by using a surface tension meter (DY-300, manufactured by Kyowa Interface Science Co., Ltd.), and the viscosity was measured in accordance with JIS Z8809 by using a vibration type viscometer (VM-100, manufactured by SEKONIC CORPORATION).

### 6. Manufacturing of Recorded Matter

### Example B1

First, a transfer medium (print film for DTF, manufactured by Ink Mania LLC) provided with a release layer made of a release agent was prepared on a base material made of polyethylene terephthalate.

Next, an ink jet recording apparatus (SC-F2150 manufactured by Seiko Epson Corporation) was filled with the ink for image formation obtained in Preparation Example 1 and the treatment liquid obtained in Example A1, and the ink for image formation was ejected from an ink jet head onto a surface of a transfer medium provided with the release layer to form a first layer having a predetermined pattern.

Next, a second layer having the same pattern as the first layer was formed by ejecting the treatment liquid from the ink jet head to overlap the first layer.

Next, the transfer medium on which the first layer and the second layer were formed was dried by subjecting the transfer medium to oven heating under conditions of a temperature of 160° C. for 2 minutes.

Next, the first layer and the second layer of the transfer medium 1 were heat-transferred to a medium to be transferred by heat-pressing the surface on which the first layer and the second layer of the transfer medium 1 were formed in a state of facing a polyester fabric (Tropical, manufactured by Toray Industries, Inc.), which is an absorptive medium to be transferred, at a pressure of 0.5 N/m² at 130° C. for 40 seconds.

Thereafter, the transfer medium was removed to obtain recorded matter.

### Examples B2 to B15

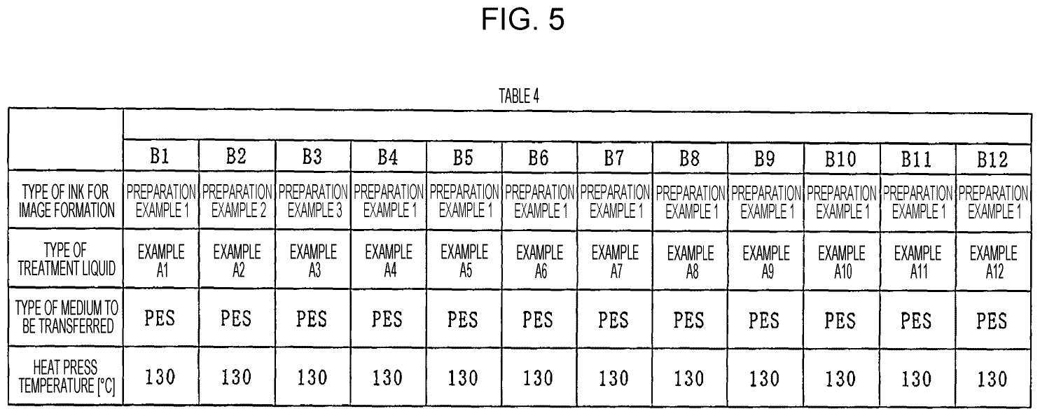

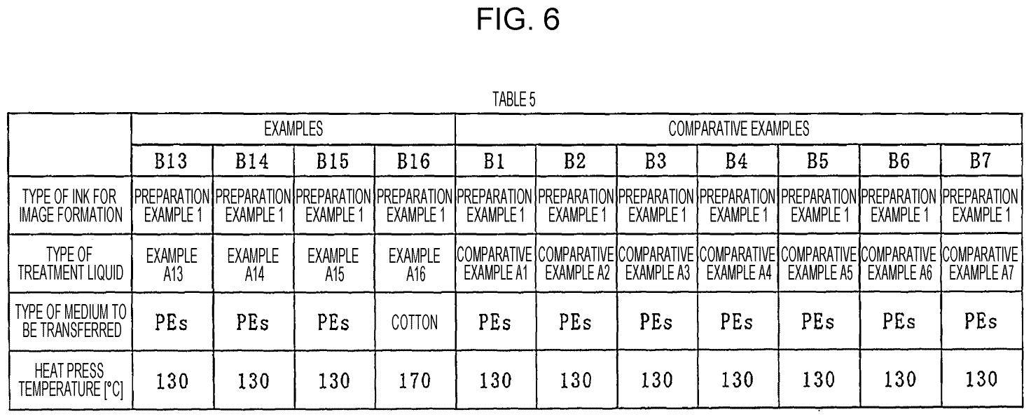

Recorded matter was manufactured in the same manner as in Example B1 above except that types of the ink for image formation and the treatment liquid were as shown in FIGS. 5 and 6.

### Example B16

Recorded matter was manufactured in the same manner as in Example B1 above except that the ink for image formation prepared in Preparation Example 1 was used as an ink for image formation, the treatment liquid prepared in Example A16 was used as a treatment liquid, a cotton broadcloth (#4000) manufactured by Nisshinbo Holdings Inc. was used as a medium to be transferred, and a temperature at the time of heat press was set to 170° C.

### Comparative Examples B1 to B7

Recorded matter was manufactured in the same manner as in Example B1 except that types of the ink for image formation, the treatment liquid, and the medium to be transferred were as shown in FIG. 6.

The conditions at the time of manufacturing the products of Examples B1 to B16 and Comparative Examples B1 to B7, that is, the conditions of the recording methods are collectively shown in FIGS. 5 and 6. Note that in FIGS. 5 and 6, Tropical (polyester fabric manufactured by Toray Industries, Inc.) as the medium to be transferred is indicated by “PEs”, and the cotton broadcloth (#4000) manufactured by Nisshinbo Holdings Inc. as the medium to be transferred is indicated by “cotton”.

### 7. Evaluation

The treatment liquids of Examples A1 to A16 and Comparative Examples A1 to A7, and the recorded matter manufactured by each of Examples B1 to B16 and Comparative Examples B1 to B7 were evaluated as follows.

### 7-1. Ejection Stability

As an evaluation of the ejection stability, continuous printing stability evaluation was performed on the treatment liquids of Examples A1 to A16 and Comparative Examples A1 to A7 immediately after preparation.

First, each treatment liquid was filled in an ink jet printer (product name PX-G930, manufactured by Seiko Epson Corporation) and recorded on a medium to be recorded (print film for DTF, manufactured by Ink Mania LLC). Specifically, a fill pattern that can be recorded with 100% duty at a resolution of 720 dpi horizontally and 720 dpi vertically was created and used. Printing was performed on 100 sheets with an A4 size, and the presence or absence of wrinkles and omission of a nozzle were checked, and the printed matter was evaluated according to the following criteria.

A: Ejection is possible without any abnormality.
B: Wrinkles and omission occur slightly, but are within allowable ranges.
C: Wrinkles and omission occur significantly.

### 7-2. Transferability

Regarding Examples B1 to B16 and Comparative Examples B1 to B7, the appearance of the transfer medium after transfer of a recording portion to the medium to be transferred was observed and evaluated according to the following criteria.

A: 100% of an image area printed on the transfer medium is transferred.

B: 80% or more and less than 100% of the image area printed on the transfer medium is transferred.

C: Less than 80% of the image area printed on the transfer medium is transferred.

### 7-3. Washing Fastness

The recorded matter obtained in each of Examples B1 to B16 and Comparative Examples B1 to B7 was evaluated for washing fastness as follows.

Specifically, a detergent was put into a home washing machine, and rinsing was repeated for 30 minutes. A state of each recorded matter after each rinsing was visually observed and evaluated according to the following criteria.

A: Even after 10 times of rinsing, peeling or chipping of the recording portion is not observed.

B: Peeling or chipping of the recording portion occurs slightly in one rinsing.

C: Peeling or chipping of the recording portion occurs significantly by one rinsing.

### 7-4. Migration

An occurrence situation of migration was visually observed for the recorded matter obtained in each of Examples B1 to B16 and Comparative Examples B1 to B7, and was evaluated according to the following criteria.

A: No migration is observed.

B: Migration is observed slightly.

C: Migration is observed remarkably.

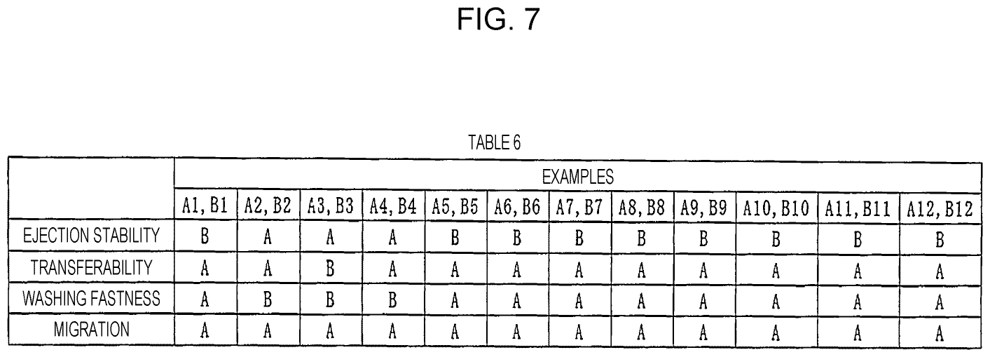

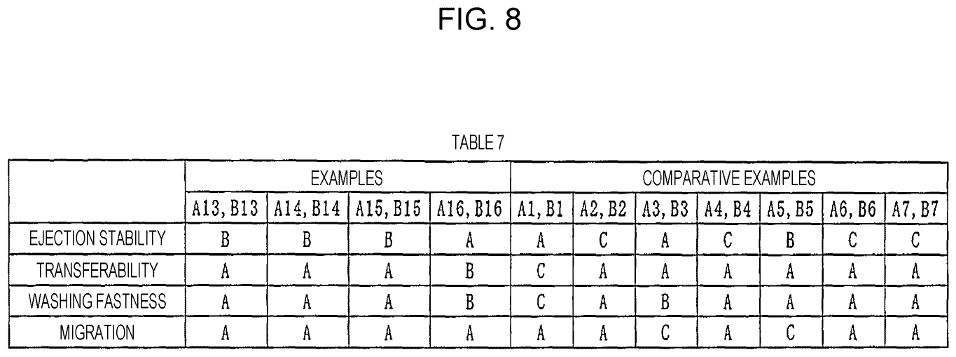

These results are collectively shown in FIGS. 7 and 8.

As is clear from FIGS. 7 and 8, excellent results were obtained in the present disclosure. In contrast, satisfactory results were not obtained with the comparative example.

What is claimed is:

1. A treatment liquid to be printed on a transfer medium, comprising a material containing resin particles, a water-soluble organic solvent, a silicone-based surfactant, and water, wherein
a content of the resin particles is 5.0% by mass or more and 20.0% by mass or less,
the water-soluble organic solvent contains a substance A and a substance B,
a content of the substance A is 5.0% by mass or more and 20.0% by mass or less,
a content of the substance B is 0.1% by mass or more and 3.0% by mass or less, and
a content of the organic solvent having a boiling point of higher than 230° C. is 10.0% by mass or less,
(provided that, the substance A is at least one compound selected from diols in which a solubility in water at 25° C. is more than 1.00 [g/100 g of H₂O] and a boiling point is 230° C. or lower, and the substance B is at least one compound selected from the group of compounds in which the solubility in water at 25° C. is 0.10 [g/100 g of H₂O] or more and 1.00 [g/100 g of H₂O] or less).

2. The treatment liquid according to claim 1, wherein
the resin particles are made of a material containing at least one of a urethane resin and a polyester resin.

3. The treatment liquid according to claim 1, wherein
the treatment liquid contains no coloring material.

4. A recording method, comprising:
a first layer forming step of forming a first layer by ejecting an ink for image formation from an ink jet head onto a transfer medium including a release layer;
a second layer forming step of forming a second layer by ejecting a treatment liquid from the ink jet head to overlap the first layer; and
a heat transfer step of heat-transferring the first layer and the second layer to an absorptive medium to be transferred by heating a surface of the transfer medium on which the first layer and the second layer are formed in a state of facing the medium to be transferred, wherein
as the treatment liquid, a treatment liquid including a material containing resin particles, a water-soluble organic solvent, a silicone-based surfactant, and water is used,
a content of the resin particles is 5.0% by mass or more and 20.0% by mass or less,
the water-soluble organic solvent contains a substance A and a substance B,
a content of the substance A is 5.0% by mass or more and 20.0% by mass or less,
a content of the substance B is 0.1% by mass or more and 3.0% by mass or less, and
a content of the organic solvent having a boiling point of higher than 230° C. is 10.0% by mass or less,
(provided that, the substance A is at least one compound selected from diols in which a solubility in water at 25° C. is more than 1.00 [g/100 g of H₂O] and a boiling point is 230° C. or lower, and the substance B is at least one compound selected from the group of compounds in which the solubility in water at 25° C. is 0.10 [g/100 g of H₂O] or more and 1.00 [g/100 g of H₂O] or less).

5. The recording method according to claim 4, wherein
as the ink for image formation, a first ink for image formation containing a coloring material of a color other than white and a second ink for image formation containing a white pigment are used.

6. The recording method according to claim 4, wherein
the transfer medium is provided with an ink-receiving layer containing an inorganic oxide.

7. The recording method according to claim 4, further comprising:
a drying step of drying the transfer medium in which the first layer and the second layer are formed between the second layer forming step and the heat transfer step.

8. The recording method according to claim 4, wherein
the heat transfer step is performed by a heat press.

9. The recording method according to claim 4, wherein
the medium to be transferred is a fabric dyed with a dye.

10. The recording method according to claim 4, wherein
the substance A contains both propylene glycol and 1,2-hexanediol,
the substance B is 2,2′-butylethyl-1,3-propanediol,
when a content of the propylene glycol in the treatment liquid is set as X_{PG} [% by mass] and a content of the 1,2-hexanediol in the treatment liquid is set as X_{HD} [% by mass], 0.10≤X_{HD}/X_{PB}≤0.60 is satisfied, and
when the content of the substance A in the treatment liquid is set as X_{A} [% by mass] and the content of the substance B in the treatment liquid is set as X_{B} [% by mass], 0.01≤X_{B}/X_{A}≤0.60 is satisfied.
